(19) United States
(12) Patent Application Publication
(10) Pub. No.: US 2005/0074135 A1
(43) Pub. Date: Apr. 7, 2005

(54) Audio device and audio processing method

(76) Inventor: Masanori Kushibe, Iwaki-city (JP)

Correspondence Address: BRINKS HOFER GILSON & LIONE, P.O. BOX 10395, CHICAGO, IL, 60610, US

(21) Appl. No.: 10/935,913

(22) Filed: Sep. 8, 2004

(30) Foreign Application Priority Data
Sep. 9, 2003 (JP) 2003-316450

(51) Int. Cl. H04R 5/00; H04R 5/02

(52) U.S. Cl. 381/310; 381/17

(57) ABSTRACT

An audio device and an audio processing method are provided for adjusting the position of a virtual speaker. The audio device comprises a decoder which has audio data provided thereto, the audio data including an audio component for a center speaker and a plurality of audio components corresponding to other speakers disposed with the center speaker interposed therewith, and which decodes these audio components to separate them from the audio data, a center delay processor for delaying the audio component for the center speaker received from the decoder, and a downmixing processor for distributing the delayed center speaker audio component between the other speakers and for merging the audio component distributed to each of the other speakers and the original audio component for each other speaker. Audio sounds corresponding to the downmixed audio components are produced from the other speakers.

### BACKGROUND OF THE INVENTION

1. Field of the Invention

The present invention relates to audio devices that distribute an audio component corresponding to a center speaker among other speakers, and audio processing methods therewith.

2. Description of the Related Art

In recent years, with the spread of a digital versatile disc (DVD) player and the like, audio devices have come into wide use that achieve a multi-channel surround which allows reproduction of a realistic sound field. For example, a multi-channel format including the so-called Dolby Digital (registered trademark), or DTS (registered trademark), includes six-channel audio data and information indicative of a combination of channels. The audio device drives a speaker corresponding to each channel using this audio data, thus enabling realistic reproduction of music.

A channel configuration included in the audio data often differs from an actual arrangement of speakers connected to the audio device. For example, although the audio data includes a component corresponding to a center speaker, the center speaker is not actually connected to the audio device. In this case, a downmixing process in which this component for the center speaker is distributed between a left front speaker and a right front speaker is carried out, as disclosed in Japanese Patent Laid-Open No. H09(1997)-259539 Publication (see p 16 to p 21, and FIGS. 16 to 36). This permits a user to listen to audio sounds corresponding to the center speaker as if they were produced from a virtual center speaker. For example, in cases where the audio data is generated or made such that speech from someone's character in a movie are produced from the center speaker, this sound component is automatically distributed between the right and left front speakers. It seems as if this sound component were produced from the center speaker.

In the device as disclosed in the above-mentioned patent publication, the downmixing process is performed to distribute the center speaker component, which is included in the audio data, among other speakers. However, the way to distribute the component is previously determined based on the actual arrangement of the speakers or the like, thus causing the problem that the position of the virtual front speaker cannot be moved.

Assuming that movie images are displayed on a monitor mounted in a vehicle and 5.1-channel sounds of this movie are produced from every speaker, sound components are often distributed between right and left speakers without providing a center speaker, because it is usually difficult to make space for the center speaker at the front center of a vehicle interior. As a result, speech from someone's character seem to be produced from a virtual center speaker. On the other hand, a center speaker component included in the Dolby Digital or DTS audio data is made or generated on the assumption that a center speaker is disposed in the midsection between right and left front speakers. Thus, the position of the virtual center speaker, which is achieved by dividing the center speaker component between the right and left speakers, coincides with the midsection between the right and left speakers. If the setting position of the monitor deviates from the midsection between the right and left front speakers, a display position of the character saying his/her line does not coincide with an output position of sounds corresponding to the line or words, which gives an unnatural impression. Alternatively, signals provided to the right and left front speakers may be subjected to a delay procedure or gain adjustment, thereby modifying or changing the output position of the sounds corresponding to the line. However, this also causes delay and fluctuations in gain with respect to original signals provided to the left and right front speakers, resulting in entirely unnatural audio sounds. Accordingly, this approach cannot substantially solve the problem described above.

### SUMMARY OF THE INVENTION

In view of the foregoing needs, it is therefore an object of the present invention to provide an audio device and an audio processing method that permits adjustment of the position of a virtual speaker.

To solve the foregoing problems, according to one aspect of the present invention, there is provided an audio device which comprises a separation section which has audio data provided thereto, the audio data including a first audio component corresponding to a first speaker and a plurality of second audio components corresponding to a plurality of second speakers, respectively, the second speakers being disposed with the first speaker interposed therebetween, and which separates the first audio component and the second audio components from the audio data, a delay section for delaying the first audio component separated by the separation section, a merging section for distributing the first audio component delayed by the delay section among the plurality of second speakers, and for merging the first delayed audio component distributed to each of the second speakers and the second audio component corresponding to each second speaker, and an audio sound output section for producing from the second speakers audio sounds corresponding to the plurality of audio components obtained by a merging operation of the merging section.

According to another aspect of the present invention, there is provided an audio processing method, with audio data being provided, the audio data including a first audio component corresponding to a first speaker and a plurality of second audio components corresponding to a plurality of second speakers, respectively, the second speakers being disposed with the first speaker interposed therebetween, the method comprising separating the first audio component and the second audio components from the audio data, delaying the separated first audio component, distributing the delayed first audio component among the plurality of second speakers to merge the delayed first audio component distributed to each of the second speakers and the second audio component corresponding to each second speaker, and producing from the second speakers audio sounds corresponding to the plurality of audio components obtained after the merging step.

Thus, the first audio component corresponding to the first speaker is delayed before being distributed among the second speakers, thereby permitting adjustment of the position of a virtual speaker, which corresponds to the first speaker, in a longitudinal direction.

The above-mentioned merging section distributes the first audio component among the plurality of second speakers in varying proportions.

Alternatively, according to still another aspect of the present invention, there is provided an audio device which comprises a separation section which has audio data provided thereto, the audio data including a first audio component corresponding to a first speaker and a plurality of second audio components corresponding to a plurality of second speakers, respectively, the second speakers being disposed with the first speaker interposed therebetween, and which separates the first audio component and the second audio components from the audio data, a merging section for distributing the first audio component separated by the separation section, among the plurality of second speakers, and for merging the first audio component distributed to each of the second speakers and the second audio component corresponding to each second speaker in varying proportions, and an audio sound output section for producing from the second speakers audio sounds corresponding to the plurality of audio components obtained by a merging operation of the merging section.

According to a further aspect of the present invention, there is provided an audio processing method, with audio data being provided, the audio data including a first audio component corresponding to a first speaker and a plurality of second audio components corresponding to a plurality of second speakers, respectively, the second speakers being disposed with the first speaker interposed therebetween, the method comprising separating the first audio component and the second audio components from the audio data, distributing the separated first audio component among the plurality of second speakers to merge the first audio component distributed to each of the second speakers and the second audio component corresponding to each second speaker in varying proportions, and producing from the second speakers audio sounds corresponding to the plurality of audio components obtained after the merging step.

Thus, when distributing the first audio component among the respective second speakers, the proportion of distribution is variable, thereby permitting adjustment of the position of a virtual speaker, which corresponds to the first speaker, in a lateral direction.

An output level changing section may be preferably provided for changing a level of output corresponding to the first audio component upon or before the merging operation of the above-mentioned merging section. Thus, before or when the first audio component corresponding to the first speaker is distributed among the respective second speakers, the output level corresponding to the first audio component is changed or altered, thereby leading to change only in the output level of the first audio component, not in those of the second audio components.

Further, a controller may be preferably provided for variably setting an amount of delay to be performed by the above-mentioned delay section. Alternatively, a controller may be preferably provided for variably setting a proportion of distribution to be performed by the above-mentioned merging section. Variably setting the amount of delay of the first audio component or the proportion of distribution thereof permits optional adjustment of the position of the virtual speaker, which corresponds to the first speaker, in the longitudinal or lateral direction.

Moreover, a setting input section manipulated by a user may be preferably provided for entering the contents of setting to be performed by the controller. This enables adjustment of the position of the virtual speaker based on the user's manipulation, whereby the position of the virtual speaker can be adjusted to a user's requirement.

Preferably, the first speaker is the center speaker, and the plurality of second speakers are a left speaker and a right speaker disposed on a left side and a right side, respectively, with the center speaker interposed therebetween. This enables audio sounds to be produced from the left and right speakers as if the center speaker, which is not actually connected to the audio device, existed, so that the position of the virtual center speaker can be adjusted.

The above-mentioned plurality of second speakers may be preferably disposed at a front side of a vehicle interior. In the case of a vehicle-mounted audio device, it is difficult to mount the first speaker as the center speaker at the front center of the vehicle interior in light of the structure of a dashboard. According to the invention, the virtual center speaker can be achieved, and its setting position is adjustable. This is of particular benefit in a setting environment where it is not easy to mount the center speaker, such as the vehicle-mounted audio device.

At a position where the above-mentioned center speaker is assumed to be set, is preferably disposed a display section for displaying images corresponding to the audio data. Generally, in the case of displaying a movie, if sounds from someone's character in the movie were produced from a display section, a more realistic movie could be achieved. However, it is actually quite difficult to accurately set the first speaker in the setting position of the display section. Even in this case, according to the present invention, the virtual speaker corresponding to the first speaker can be aligned with the setting position of the display section. In addition, the position of the virtual speaker can be adjusted such that it easily coincides with the setting position of the display section.

Preferably, the above-mentioned audio data may be in the Dolby Digital format, and an audio block in each synchronization frame of the audio data may include the audio component of the center speaker, which corresponds to the first speaker, while the delay operation may be performed by the delay section when the first speaker is not actually connected. Alternatively, the above-mentioned audio data may be in the Dolby Digital format, and an audio block in each synchronization frame of the audio data may include the audio component of the center speaker, which corresponds to the first speaker, while the merging operation may be performed by the merging section when the first speaker is not actually connected. This enables setting the position of the virtual speaker at any position, for example, at a position other than a conventional predetermined center position, in cases where the audio data in the Dolby Digital format is provided, which data includes the audio component of the center speaker.

Preferably, the above-mentioned audio data may be in the DTS format, and an audio frame in each synchronization frame of the audio data may include the audio component of the center speaker, which corresponds to the first speaker, while the delay operation may be performed by the delay section when the first speaker is not actually connected. Alternatively, the above-mentioned audio data may be in the DTS format, and the audio frame in each synchronization frame of the audio data may include the audio component of the center speaker, which corresponds to the first speaker, while the merging operation may be performed by the merging section when the first speaker is not actually connected. This enables setting the position of the virtual speaker at any position, for example, at a position other than a conventional predetermined center position, in cases where the audio data in the DTS format is provided, which data includes the audio component of the center speaker.

### BRIEF DESCRIPTION OF THE DRAWINGS

FIG. 1 is a diagram showing the general configuration of an audio device according to one preferred embodiment of the present invention;

FIG. 2 is a diagram showing an audio data format corresponding to Dolby Digital, provided to the audio device of FIG. 1;

FIG. 3 is a diagram showing an arrangement of a display section and speakers in the audio device according to the preferred embodiment;

FIG. 4 is a diagram showing a partially detailed configuration of the audio device according to the preferred embodiment; and

FIG. 5 is a diagram showing an audio data format corresponding to DTS.

### DESCRIPTION OF THE PREFERRED EMBODIMENTS

An audio device according to one preferred embodiment of the present invention will be described in detail hereinafter with reference to the accompanying drawings.

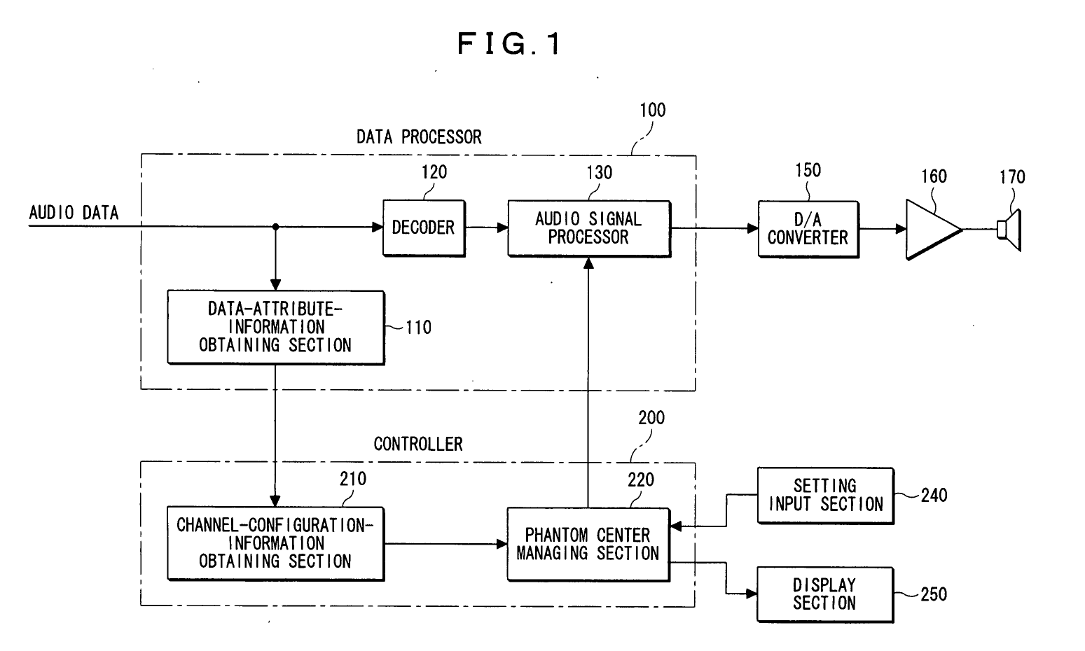

FIG. 1 illustrates the general configuration of an audio device according to one preferred embodiment of the invention. As shown in FIG. 1, the audio device of the present embodiment includes a data processor 100, a digital/analog (D/A) converter 150, an amplifier 160, a speaker 170, a controller 200, a setting input section 240, and a display section 250. The audio device, which is mounted in a vehicle, has multi-channel audio data provided thereto, which data includes a center speaker component. This device has a downmixing function of distributing the center speaker component among a plurality of other speakers 170 and of merging the component distributed and original components for the respective other speakers.

The data processor 100 has encoded audio data provided thereto, which data has a predetermined channel component, and applies various procedures to a result obtained by decoding this audio data. For this reason, the data processor 100 includes a data-attribute-information obtaining section 110, a decoder 120, and an audio signal processor 130.

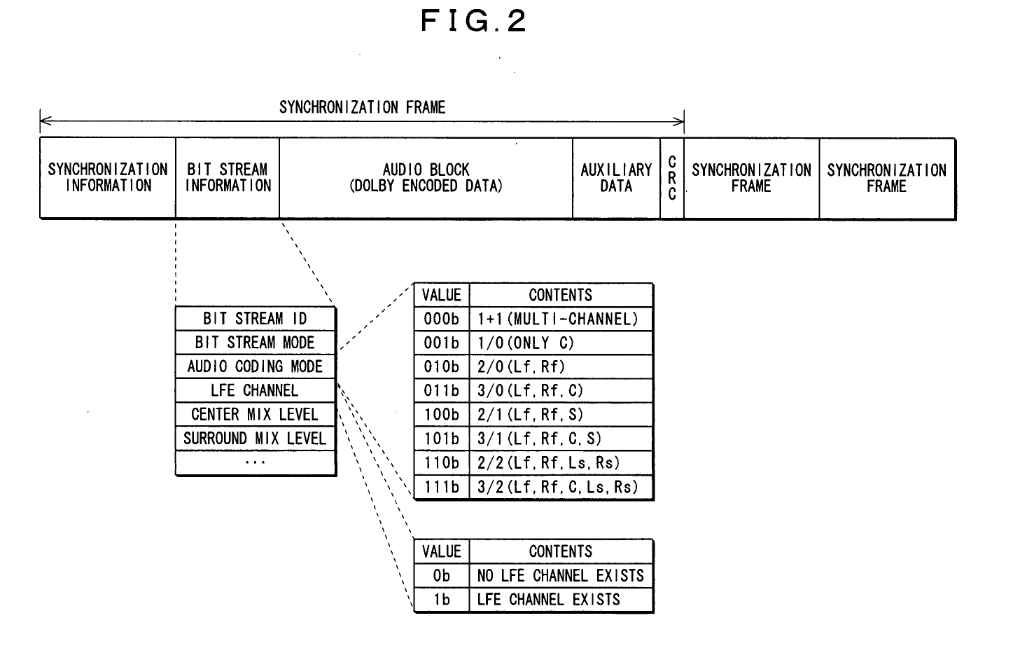

FIG. 2 illustrates a format of the audio data which is provided to the audio device of FIG. 1, e.g., a format corresponding to Dolby Digital. As shown in FIG. 2, the audio data in the Dolby Digital format is composed of some synchronization frames. Each synchronization frame consists of several pieces of information, i.e. “synchronization information”, “bit stream information”, “audio block”, “auxiliary data”, and “CRC”.

Among them, the “bit stream information” is equivalent to header information indicative of data attribute information of the audio data, and includes several elements, i.e., a “bit stream ID”, a “bit stream mode”, an “audio coding mode”, a “LFE channel”, a “center mix level”, a “surround mix level”, and the like. The “audio coding mode” indicates the channel configuration of the audio data, the contents of which configuration are represented by 3 bits. For example, in the case of “011b” represented by 3 bits, in which b indicates that each digit has 1 bit data, it is seen that the channel configuration includes audio components only for left and right front speakers Lf and Rf and a center front speaker C, not for left and right rear speakers Ls and Rs and a rear subwoofer S. It should be noted that “contents” of the audio coding mode as shown in FIG. 2 indicate the configuration of speakers on front and rear sides, and numerals disposed before and after a mark “/” indicate the number of speakers on front and rear sides, respectively. “L numeral” indicates the number of speakers on front and rear sides. The “LFE channel” indicates the presence or absence of a low frequency effect (LFE) channel, that is, the presence or absence of an audio component corresponding to a rear subwoofer S that causes a low frequency effect. In the case of the value of “0b”, it shows that the audio component corresponding to the subwoofer S as the LFE channel is not included. In the case of “1b”, it shows that the audio component corresponding to the subwoofer S as the LFE channel is included.

The “audio block” information includes encoded audio data corresponding to audio components for a plurality of channels, which are represented by the audio coding mode in the bit stream information.

The data-attribute-information obtaining section 110 obtains data attribute information included in the bit stream information in each synchronization frame. The decoder 120 carries out decoding of the respective pieces of audio data for a plurality of channels, which are included in the audio block of each synchronization frame. The audio signal processor 130 performs various kinds of signal processing using the decoded audio data, to generate new audio data corresponding to speakers 170 which are actually connected to the audio device of the present embodiment. The various kinds of signal processing include the downmixing process, base management processing, delay procedure, and speaker level adjustment processing, and explanations thereof will be described hereinafter.

The controller 200 performs control to variably set the position and the output level of a virtual center speaker serving as a phantom center in the audio device of the present embodiment. For this reason, the controller 200 includes a channel-configuration-information obtaining section 210 and a phantom center managing section 220. The channel-configuration-information obtaining section 210 obtains channel configuration information from the data attribute information obtained by the data-attribute-information obtaining section 110 in the data processor 100. More concretely, the “audio coding mode” and the “LFE channel” included in the bit stream information relate to the channel configuration information. Such data is extracted.

The phantom center managing section 220 sets various kinds of factor values and/or delay values which are to be used when distributing an audio component corresponding to the center speaker C between the left and right front speakers Lf and Rf so as to variably adjust the position of the virtual center speaker. These set values are sent to the audio signal processor 130 in the data processor 100.

The phantom center managing section 220 is connected to a setting input section 240 and a display section 250. The setting section 240 is for a user to specify a setting, e.g., to enter necessary values and instructions so as to change the position and the output level of the virtual center speaker. The display section 250 is for the user to confirm the contents of input operations and entered values, which are set by the setting input section 240. In the audio device of the present embodiment, this display section 250 serves as a monitoring device for a DVD player, a digital broadcast receiver, (both of which are not shown in the figure) or the like. For example, various kinds of setting are performed by the phantom center managing section 220, whereby the position of the virtual center speaker can coincide with the setting position of the display section 250 on which an actor is displayed when reproducing a movie.

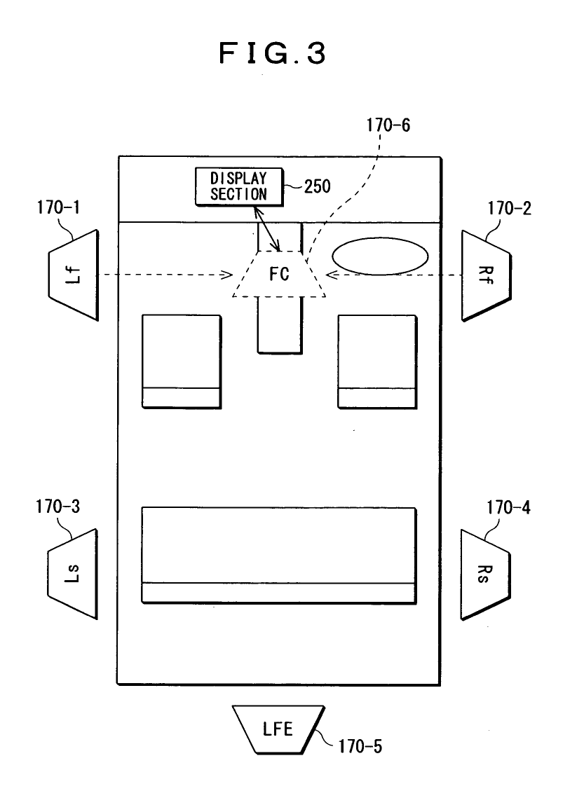

FIG. 3 illustrates an arrangement of the speakers 170 and the display section 250 in the audio device of the present embodiment. In the present embodiment, for example, five kinds of speakers 170-1 to 170-5 are used. The speaker (Lf) 170-1 is disposed at a left front side; the speaker (Rf) 170-2 at a right front side; the speaker (Ls) 170-3 at a left rear side; and the speaker (Rs) 170-4 at a right rear side. The speaker (LFE) 170-5 is a subwoofer disposed at the center rear side. In the present embodiment, a center speaker (FC), which would be disposed on the center front side, is not actually provided. Instead of the center speaker, an audio component for this center speaker is subjected to the downmixing process to be distributed between the speakers 170-1 and 170-2, thus achieving the virtual speaker 170-6 as the phantom center. In the embodiment, the display section 250 is disposed in a predetermined position on the front side, e.g., a position displaced left forward with respect to the midsection between the left and right front speakers 170-1 and 170-2.

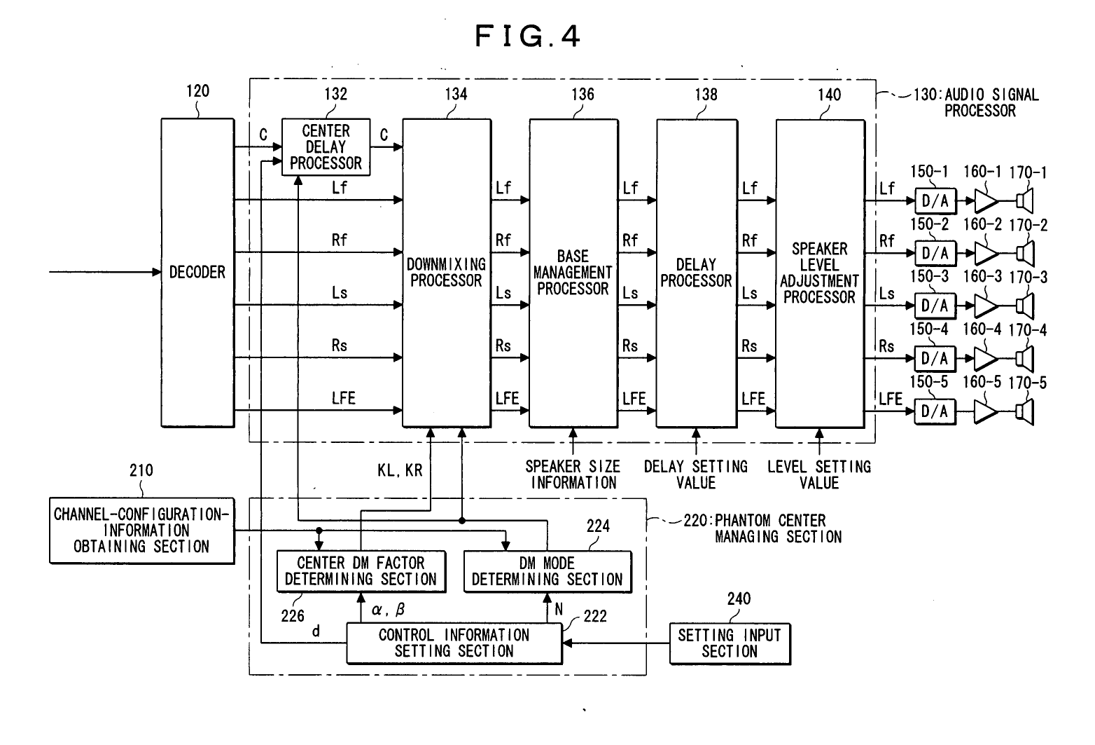

FIG. 4 illustrates a partially detailed configuration of the audio device of the present embodiment. As shown in FIG. 4, the phantom center managing section 220 includes a control information setting section 222, a downmixing (DM) mode determining section 224, and a center DM factor determining section 226.

The control information setting section 222 sets “the number of speakers N” which are actually connected to the audio device of the present embodiment, “the amount of delay d” for displacing or moving the position of the virtual center speaker forward, “the amount of downmixing adjustment β” for displacing or moving the position of the virtual center speaker in the lateral direction, “the amount of adjustment of output level α” for changing the level of output from the virtual center speaker, or the like, based on input values and/or instructions provided by the setting input section 240.

The DM mode determining section 224 determines a DM mode used when performing the downmixing process, based on the channel configuration information obtained from the audio data by the channel configuration information obtaining section 210, and on the number of speakers N set by the control information setting section 222. This DM mode is an operation mode which is determined by a combination of the channel configuration corresponding to the audio component and the connection state of the actual speakers 170. Once this DM mode is determined, it is automatically determined what proportion of the audio component for each channel is to be provided to each speaker 170 actually connected to the audio device.

The center DM factor determining section 226 determines a DM factor to be used when distributing the audio component for the center speaker among other speakers 170. In the present embodiment, the output level of the virtual center speaker 170-6 can be freely set, and hence taking the changing state of this output level into consideration, the DM factor is determined.

For instance, more generally, the audio component for the center speaker is distributed between the left front speaker (Lf) 170-1 and the right front speaker (Rf) 170-2. In the prior art, if the audio component for the center speaker is D(C), it is distributed between the left front speaker (Lf) 170-1 and the right front speaker (Rf) 170-2, each by Cm×D(C). Note that Cm is a center mix level included in the bit stream information shown in FIG. 2.

On the other hand, in the present embodiment, a component of α×(Cm+β)×D(C) is distributed to the left front speaker (Lf) 170-1, while a component of α×(Cm−β)×D(C) is distributed to the right front speaker (Rf) 170-2. The center DM factor determining section 226 determines two kinds of center DM factors KL (=α×(Cm+β)) and KR (α×(Cm−β)), which serve as factors for distributing the audio component for the center speaker between the left front speaker 170-1 and right front speaker 170-2, respectively.

The audio signal processor 130 includes a center delay processor 132, a downmixing processor 134, a base management processor 136, a delay processor 138, and a speaker level adjustment processor 140.

The center delay processor 132, when the audio data decoded for the center speaker is produced from the decoder 120, delays an output timing of this decoded audio data by a time period corresponding to the “amount of delay”, which has been set by the control information setting section 222 in the phantom center managing section 220.

The downmixing processor 134, into which the decoded audio data for the center speaker received from the center delay processor 132 and decoded audio data for other channels are supplied, performs the downmixing process of the audio data for these respective channels in compliance with the connection state of the actual speakers 170, based on the DM mode and the center DM factor determined by the DM mode determining section 224 and the center DM factor determining section 226 in the phantom center managing section 220, respectively.

For example, in cases where the center speaker component is distributed between the left front speaker (Lf) 170-1 and the right front speaker (Rf) 170-2, the audio components D1 (Lf) and D1 (Rf) for the respective speakers are obtained by using the following formulas for processing.
D1(Lf)=(1.0×D0(Lf))+(KL×D(C))=(1.0×D0(Lf))+(α×(Cm+β)×D(C))
D1(Rf)=(1.0×D0(Rf))+(KR×D(C))=(1.0×D0(Rf))+(α×(Cm−β)×D(C))

In the base management processor 136, when an audio component for any one of the input channels includes a low frequency component and a speaker 170 corresponding to this channel is actually connected without having reproducing ability of the low frequency component, this low frequency component is distributed among other speakers 170. For example, suppose that audio components corresponding to the left rear speaker (Ls) 170-3 and the right rear speaker (Rs) 170-4 include low frequency components, and these speakers 170-3 and 170-4 have apertures so small that it is sometimes difficult to reproduce the low frequency components. In this case, these low frequency components are distributed to the speaker 170-5 serving as a subwoofer that has the ability to reproduce the low frequency components, which distribution processing is performed by the base management processor 136.

The delay processor 138 delays an output timing of the audio component corresponding to each of the speakers 170-1 to 170-5 for a predetermined time period. This causes the timing at which the audio sound is provided from each speaker to be delayed, whereby a position from which the audio sounds are perceived to be generated can be changed.

The speaker level adjustment processor 140 performs adjustment processing of output levels among the speakers 170-1 to 170-5. Note that processing performed by the above-mentioned base management processor 136, delay processor 138, and speaker level adjustment processor 140 are conventional.

The audio component for the left front speaker produced from the speaker level adjustment processor 140 is converted into analog audio signals by the digital analog (D/A) converter 150-1, which signals are then amplified by the amplifier 160-1 to be produced from the speaker 170-1. Similarly, the audio component for the right front speaker produced from the speaker level adjustment processor 140 is converted into analog audio signals by the digital analog (D/A) converter 150-2, which signals are then amplified by the amplifier 160-2 to be produced from the speaker 170-2. The audio component for the left rear speaker produced from the speaker level adjustment processor 140 is converted into analog audio signals by the digital analog (D/A) converter 150-3, which signals are then amplified by the amplifier 160-3 to be produced from the speaker 170-3. The audio component for the right rear speaker produced from the speaker level adjustment processor 140 is converted into analog audio signals by the digital analog (D/A) converter 150-4, which signals are then amplified by the amplifier 160-4 to be produced from the speaker 170-4. The audio component for the center rear speaker produced from the speaker level adjustment processor 140 is converted into analog audio signals by the digital analog (D/A) converter 150-5, which signals are then amplified by the amplifier 160-5 to be produced from the speaker 170-5.

The above-mentioned decoder 120 corresponds to a separation section; the center delay processor 132 to a delay section; and the downmixing processor 134 to a merging section. The base management processor 136, the delay processor 138, the speaker level adjustment processor 140, the digital analog converter 150, and the amplifier 160 correspond to an audio sound output section; the downmixing processor 134 to an output level changing section; the phantom center managing section 220 to a controller; and the setting input section 240 to a setting input section, respectively.

Thus, the audio component corresponding to the center speaker is delayed by the center delay processor 132 before being distributed between the speakers 170-1 and 170-2, thereby permitting adjustment of the position of the virtual center speaker in the longitudinal direction. In addition, the audio component corresponding to the center speaker is distributed between the speakers 170-1 and 170-2 in varying proportions, thereby permitting adjustment of the virtual center speaker position in the lateral direction.

When the downmixing process is performed by the downmixing processor 134, the output level of the audio component for the center speaker is changed or altered, so that the audio component of the virtual center speaker can be changed without altering the original output levels of the audio components from the speakers 170-1 and 170-2.

Variable setting of the amount of delay (delay amount d) and the proportion of distribution (downmixing adjustment value β) of the audio component for the center speaker by the phantom center managing section 220 can variably adjust the position of the virtual center speaker, which corresponds to the first speaker, in the longitudinal or lateral direction.

Provision of the setting input section 240 which is manipulated by a user allows the user to adjust the position of the virtual center speaker by his/her own operation, whereby the virtual center speaker can be adjusted to the user's requirement.

The present invention is not limited to the foregoing embodiment, but may be modified within the scope of the appended claims. In the above embodiment, a case where the audio data input is in a format corresponding to the Dolby Digital has been explained. The invention may be applied to a case where the audio data in another format, for example, audio data compressed by the MPEG format, is supplied.

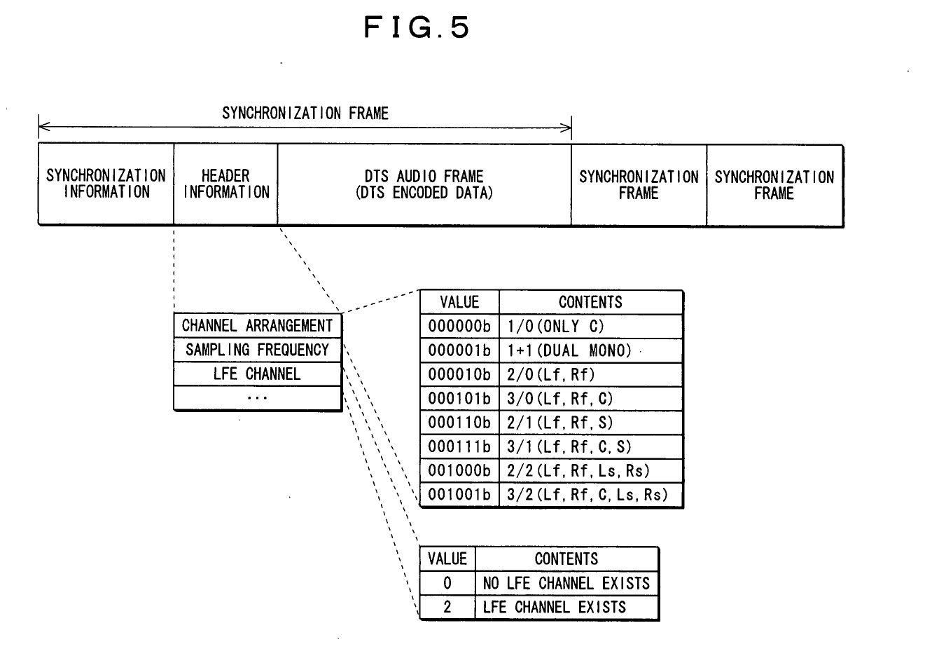

FIG. 5 illustrates a format for the audio data which corresponds to the DTS. As shown in FIG. 5, the audio data in the DTS format is composed of some synchronization frames, in the same manner as the audio data in the Dolby Digital format of FIG. 2. Each synchronization frame consists of several pieces of information, i.e. “synchronization information”, “header information”, and “DTS audio frame”. Among them, the “header information” indicates data attribute information of the audio data, and includes several elements, i.e., “channel arrangement”, “sampling frequency”, “LFE channel”, or the like. The “channel arrangement” indicates the channel configuration of the audio data, the contents of which configuration are represented by 6 bits. For example, in the case of “000101b” represented by these bits, it is seen that the channel configuration includes audio components only for left and right front speakers Lf and Rf and a center front speaker C, not for left and right rear speakers Ls and Rs and a rear subwoofer S. The “DTS audio frame” includes coded audio data corresponding to audio components for a plurality of channels represented by the channel arrangement in the header information. As described above, the contents of the DTS format of the audio data are similar to those of the Dolby Digital format of the digital data. The invention may be applied to a case where the audio data includes the center speaker component, but the center speaker is not actually connected to the device.

It should be noted that although the Dolby Digital format includes the center mix level Cm, the DTS format does not include information corresponding thereto, and the downmixing process is conventionally carried out using the fixed value (=0.71). Therefore, in the application of the present invention, two kinds of center DM factors, namely, KL and KR, will be calculated by the center DM factor determining section 226 based on the following formulas.
KL=α×(0.71+β)
KR=α×(0.71−β)

It should be noted that although in the above embodiments, the audio device of the invention is a vehicle-mounted audio device, the invention is not limited thereto. The invention may be applied to an audio device to be mounted on any conveyances or to be used in places other than the vehicle interior space, e.g., home use.

In the above embodiments, the audio component for the center front speaker is distributed among other speakers, but the invention may be applied to a case where the audio component for the center rear speaker is distributed among other speakers.

Although in the described embodiments, the audio data is encoded in the Dolby Digital format, the invention is not limited hereto. The audio data including uncoded audio data in the PCM format or the like may be supplied in the audio device of the invention. In this case, the decoder 120 may separate and extract PCM data corresponding to each channel, instead of performing the decoding process, which data may be then produced.

In the described embodiments, when the downmixing process is carried out by the downmixing processor 134, the output level of the audio component for the center speaker is changed using the output level adjustment value. This changing process may be executed by a special processor before the audio component is provided to the downmixing processor 134, that is, at a stage preceding or following the center delay processor 132.

It is to be understood that a wide range of changes and modifications to the embodiments described above will be apparent to those skilled in the art and are contemplated. It is therefore intended that the foregoing detailed description be regarded as illustrative, rather than limiting, and that it be understood that it is the following claims, including all equivalents, that are intended to define the spirit and scope of the invention.

1. An audio device comprising:
a separation section which has audio data provided thereto, the audio data including a first audio component corresponding to a first speaker and a plurality of second audio components corresponding to a plurality of second speakers, respectively, the second speakers being disposed with said first speaker interposed therebetween, and which separates said first audio component and said second audio components from the audio data;
a delay section for delaying said first audio component separated by said separation section;
a merging section for distributing said first audio component delayed by said delay section, among said plurality of second speakers, and for merging said first delayed audio component distributed to each of the second speakers and said second audio component corresponding to said each second speaker; and
an audio sound output section for producing from said second speakers audio sounds corresponding to the plurality of audio components obtained by a merging operation of said merging section.

2. The audio device according to claim 1, further comprising an output level changing section for changing a level of output corresponding to said first audio component upon or before the merging operation of said merging section.

3. The audio device according to claim 1, further comprising an output level changing section for changing the level of output corresponding to said first audio component upon or before the merging operation of said merging section, and a controller for variably setting an amount of delay to be performed by said delay section.

4. The audio device according to claim 1, wherein said merging section distributes said first audio component among said plurality of second speakers in varying proportions.

5. The audio device according to claim 4, wherein said audio data is in Dolby Digital format, and wherein an audio block in each synchronization frame of said audio data includes the audio component of a center speaker, which corresponds to said first speaker, and when said first speaker is not actually connected, a delay operation is performed by said delay section.

6. The audio device according to claim 1, further comprising a controller for variably setting the amount of delay to be performed by said delay section.

7. The audio device according to claim 6, further comprising a setting input section manipulated by a user for entering contents of a setting to be performed by said controller.

8. The audio device according to claim 1, wherein said first speaker is a center speaker, and said plurality of second speakers includes a left speaker and a right speaker disposed on a left side and a right side, respectively, with said center speaker interposed therebetween.

9. The audio device according to claim 8, wherein said plurality of second speakers are disposed toward the front of a vehicle interior.

10. The audio device according to claim 8, wherein at a position where said center speaker is perceived to be set, a display section for displaying images corresponding to said audio data is disposed.

11. The audio device according to claim 1, wherein said audio data is in the Dolby Digital format, and wherein the audio block in each synchronization frame of said audio data includes the audio component of the center speaker, which corresponds to said first speaker, and when said first speaker is not actually connected, the merging operation is performed by said merging section.

12. The audio device according to claim 1, wherein said audio data is in DTS format, and wherein an audio frame in each synchronization frame of said audio data includes the audio component of the center speaker, which corresponds to said first speaker, and when said first speaker is not actually connected, the delay operation is performed by said delay section.

13. The audio device comprising:
a separation section which has audio data provided thereto, the audio data including a first audio component corresponding to a first speaker and a plurality of second audio components corresponding to a plurality of second speakers, respectively, the second speakers being disposed with said first speaker interposed therebetween, and which separates said first audio component and said second audio components from the audio data;
a merging section for distributing said first audio component separated by said separation section among said plurality of second speakers, and for merging said first audio component distributed to each of the second speakers and said second audio component corresponding to said each second speaker in varying proportions; and
an audio sound output section for producing from said second speakers audio sounds corresponding to the plurality of audio components obtained by a merging operation of said merging section.

14. The audio device according to claim 13, further comprising a controller for variably setting a proportion of distribution to be performed by said merging section.

15. The audio device according to claim 13, wherein said audio data is in the DTS format, and wherein the audio frame in each synchronization frame of said audio data includes the audio component of the center speaker, which corresponds to said first speaker, and when said first speaker is not actually connected, the merging operation is performed by said merging section.

16. A method for processing audio data, said audio data including a first audio component corresponding to a first speaker and a plurality of second audio components corresponding to a plurality of second speakers, respectively, the second speakers being disposed with said first speaker interposed therebetween, the method comprising:
separating said first audio component and said second audio components from the audio data;
delaying said separated first audio component;
distributing said delayed first audio component among said plurality of second speakers to merge said delayed first audio component distributed to each of the second speakers and said second audio component corresponding to said each second speaker; and
producing from said second speakers audio sounds corresponding to the plurality of audio components obtained after the merging act.

17. A method for processing audio data, said audio data including a first audio component corresponding to a first speaker and a plurality of second audio components corresponding to a plurality of second speakers, respectively, the second speakers being disposed with said first speaker interposed therebetween, the method comprising:
separating said first audio component and said second audio components from the audio data;
distributing said separated first audio component, among said plurality of second speakers to merge said first audio component distributed to each of the second speakers and said second audio component corresponding to said each second speaker in varying proportions; and
producing from said second speakers audio sounds corresponding to the plurality of audio components obtained after the merging act.

18. The method according to claim 17, further comprising:
changing a level of output corresponding to said first audio component upon or before said act of distributing.

19. The method according to claim 17, wherein said first speaker is a center speaker, and said plurality of second speakers includes a left speaker and a right speaker disposed on a left side and a right side, respectively, with said center speaker interposed therebetween.

20. The method according to claim 19, wherein images corresponding to said audio data are displayed at a position where said center speaker is perceived to be set.
